(19) United States
(12) Patent Application Publication
(10) Pub. No.: US 2017/0192439 A1
(43) Pub. Date: Jul. 6, 2017

(54) AN UNDERWATER BODY FOR REMOTELY OPERATED VEHICLE AND AN AUTONOMOUS OBSTACLE AVOIDANCE METHOD THEREOF

(71) Applicant: Shanghai Maritime University, Shanghai (CN)

(72) Inventors: Daqi ZHU, Shanghai (CN); Zhigang DENG, Shanghai (CN); Bing SUN, Shanghai (CN); Fang YUAN, Shanghai (CN); Nengjun WANG, Shanghai (CN)

(73) Assignee: Shanghai Maritime University, Shanghai (CN)

(21) Appl. No.: 15/313,411

(22) PCT Filed: Nov. 6, 2015
(86) PCT No.: PCT/CN2015/094027

§ 371 Date: Nov. 22, 2016

(30) Foreign Application Priority Data
Apr. 15, 2015 (CN) 201510177010.7

(51) Int. Cl. G05D 1/10; G05D 1/08; G01S 15/93; G05D 1/00

(52) U.S. Cl. CPC G05D 1/10; G05D 1/0011; G05D 1/0022; G05D 1/0875; G01S 15/93

(57) ABSTRACT

An underwater body for remotely operated vehicle which includes: main control system which communicates with the control center above the water with optical composite cable and receive remote control command from the center above water and upload the video information and sensor data for subsea; rotation platform equipped with video receiver, and the input terminal of the rotation platform is connected with the main control system, while the main control system controls the rotation platform according to the control command and cause the video receiver to rotate; sensor system comprising sonar component, the sonar component would detect the subsea environment in real-time manner and transmit the subsea environment information to main control system, where the main control system deliver movement control command to the movement component of the underwater body based on the subsea environment information. Optical fiber transmission technology is adopted in this invention disclosure. It is practical to obtain high quality real-time high definition video and telemetering data in remote manner, with a comparatively high operation flexibility and realize autonomous obstacle avoidance with the application of sonar detection.

### FIELD OF THE INVENTION

This invention relates to an underwater operated vehicle, and more particularly to an underwater body for remotely operated vehicle and an autonomous obstacle avoidance method thereof.

### BACKGROUND OF THE INVENTION

Remotely operated vehicle, serving as a capable assistance for human to research and explore the ocean, is playing a more and more significant role in the field of ocean engineering, especially in the subsea cable routing, subsea rescue and maintenance of subsea military facility as well as other fields of engineering. Remotely operated vehicle demonstrates high significance in the exploration of ocean as the device is capable of comprehensive investigation and research, and to complete various tasks in a depth that is impossible for diver to reach.

However, the efficient control over the remotely operated vehicle turns out to be a technique difficulty as the unknown and various ocean environments are unknown and various, more complex than the land environment. The device could be categorized into ROV (Remotely Operated Vehicle) and AUV (Autonomous Underwater Vehicle) from the aspect of control pattern. Considering the low cost, simple and convenient control and good real time information interact performance of remotely operated vehicle, as well as the power demand by the manipulator and complex underwater exploration device, remotely operated vehicle is still the most wide-spread and important device for underwater exploration and investigation from the aspect of decision-making and operation level. While the design of the underwater body, the critical component of remotely operated vehicle, turn out to be of great importance. The underwater body of remotely operated vehicle is the part that would execute the detailed tasks when the remotely operated vehicle is operating under water, it would execute the manual operation by the operator above the water and transmit the local information of underwater environment as well as all information about the device itself to the center above water. At present, the communication of the body of remotely operated vehicles both in domestic and abroad is mainly transmitted by twisted pair; the communication quality is not desirable, the transmission effect, especially for the high definition underwater video, is usually not satisfied.

### DISCLOSURE OF THE INVENTION

The present invention relates to an underwater body for remotely operated vehicle and an autonomous obstacle avoidance method thereof, the device is capable of movements of four degree of freedom, avoid obstacles in autonomous manner, and provide high quality real time high definition video and telemetering data, with flexible manipulation.

For the purpose above, the present invention is aimed to provide an underwater body for remotely operated vehicle fixed in the frame of remotely operated vehicle, wherein, said underwater body includes:

Main control system which communicates with the control center above the water with optical composite cable and receives remote control command from the center above water and uploads the video information and sensor data for subsea;

Rotation platform equipped with video receiver, and the input terminal of the rotation platform communicates with the main control system, while the main control system controls the rotation platform according to the control command and cause the video receiver to rotate;

Sensor system which comprises sonar component, the sonar component would detect the subsea environment in real-time manner and transmit the subsea environment information to main control system, where the main control system deliver movement control command to the movement component of the underwater body based on the subsea environment information.

The said main control system includes:

Embedded main control board which uploads the sensor data from sensor system to the control center above the water, receive remote control command from the control center above water, analyze the command received, and then deliver the movement control command to the underwater body;

Data collection board which communicates with the embedded main control board, receives the digital and analogue sensor data from sensor system and transmits such data to the embedded main control board, then delivers the movement control command to the movement component of the underwater body;

Multi-serial port board which communicates with the embedded main control board, receives the sensor data from RS485 and RS232 in sensor system and transmit such data to the embedded main control board; the multi-serial port board also connects with optical composite cable; the embedded main control board connects with the control center above water with multi-serial port board.

The said main control system communicates with optical cable connection board with optical terminal, and connects optical composite cable via optical cable connection board, thus to establish communication with control center above water via optical composite cable.

The said underwater body also includes power system, such power system serves as the movement component of the underwater body, receives the movement control command transmitted from the main control system and provides power for the movements of remotely operated vehicle.

The said power system includes:

Vertical propeller which is arranged in the bow and stern ends in the vertical section of remotely operated vehicle, to control the diving and floating as well as trim movement of the remotely operated vehicle;

Stern propeller which is arranged in both the left side and right side of stern in the frame of the remotely operated vehicle, to control the forward and backward movement as well as heading movement of the remotely operated vehicle;

Said underwater body also includes power distribution board, the input terminal of said board connects with optical cable connection board to receive the power delivered from the optical cable connection board, and distribute the power to optical terminal, main control system, rotation platform, sensor system and movement component in the underwater body.

Said sonar system includes:

Ranging sonar which is arranged in the upper front end in the remotely operated vehicle, to measure the distance to the target ahead or to obstacles, then transmit the measured distance data to the main control system and control center above water for processing;

Forward-looking sonar which is arranged in the upper part of the front end in said remotely operated vehicle, to detect the condition of ambient target or obstacles of same horizontal level, then transmit the measured distance data to the main control system and control center above water for processing.

The said sensor system includes:

Camera, serves as video receiving device, which is arranged in the front of said remotely operated vehicle and connected with rotation platform, would be rotate driven by the rotation platform, to collect the image data, transmit the data to the control center above water via the main control system;

Pressure sensor, which is arranged in the lower rear part of underwater body, to inspect the depth where the remotely operated vehicle located and transmit the collected depth data to the control center above water via the main control system;

Altimeter, to measure the altitude where the remotely operated vehicle located, and to transmit the collected altitude data to the control center above water via the main control system;

Gyroscope, which is arranged inside the vessel of underwater body, to measure the heading angular velocity of the remotely operated vehicle and transmit the collected angular velocity data to the control center above water via the main control system;

Electronic compass, which is arranged inside the vessel of underwater body, to measure the heading angle, trim angle and rolling angle of the remotely operated vehicle and transmit the collected angular velocity data to the control center above water via the main control system;

Voltage current sensor, which is arranged inside the vessel of underwater body, to measure the voltage and current information of each part of the remotely operated vehicle, and to transmit the collected angular velocity data to the control center above water via the main control system.

An autonomous obstacle avoidance method deployed in underwater body for remotely operated vehicle, said obstacle avoidance method comprises:

Step 1, the forward-looking sonar and ranging sonar would detect the ambient of the remotely operated vehicle, then transmit the image and distance data generated to the main control system;

Step 2, the main control system would process the image and distance data from forward-looking sonar and ranging sonar, obtain the location and distance relationship between the remotely operated vehicle and ambient obstacles;

Step 3, the main control system would adjust the movement parameters and transmit movement control command to power system based on the location and distance relationship between the remotely operated vehicle and ambient obstacles;

Step 4, the power system would drive the remotely operated vehicle to avoid obstacles then skip to step 1 and realize autonomous obstacle avoidance in cycle.

Compared with the present body of remotely operated vehicle, the advantages of the underwater body and autonomous obstacle avoidance method are that the main control system is connected with the control center above water with optical fiber transmission technology, with this technology, it is practical to obtain high quality real-time high definition video and telemetering data in remote manner, with a comparatively high operation flexibility.

For the purpose of a better underwater performance, the invention deployed forward-looking sonar and range sonar, meanwhile the main control system would judge the location of obstacles in the ambient where the remotely operated vehicle worked based on the image and distance data detected by the forward-looking sonar and ranging sonar, and then transmit the movement control command; the device is capable of autonomous obstacle avoidance which is not available in common remotely operated vehicle;

The camera is driven by rotation platform to rotate in this invention, it is more practical to carry out remote manipulation for camera and expand the observation scope of the camera, the disadvantages of traditional fix installed or integrated platforms are prevented, thus the performance of the camera in the above mentioned platform is better than that in the integrated platform, and the underwater observation scope would be enlarged as well.

### BRIEF DESCRIPTION OF THE DRAWINGS

FIG. 1 is a drawing of system modular in an underwater body for remotely operated vehicle;

FIG. 2 is a schematic connection drawing of power distribution board in an underwater body for remotely operated vehicle;

FIG. 3 is a process drawing of autonomous obstacle avoidance method in an underwater body for remotely operated vehicle.

### THE PREFERRED EMBODIMENT OF THE INVENTION

The preferred embodiment of this invention is further described with the reference of drawings.

This invention is disclosed an embodiment of underwater body for remotely operated vehicle, the underwater body is fixed in the aluminum alloy frame of the remotely operated vehicle, the underwater body is arranged inside a sealed electronic case which is used to place control circuit and electric equipment.

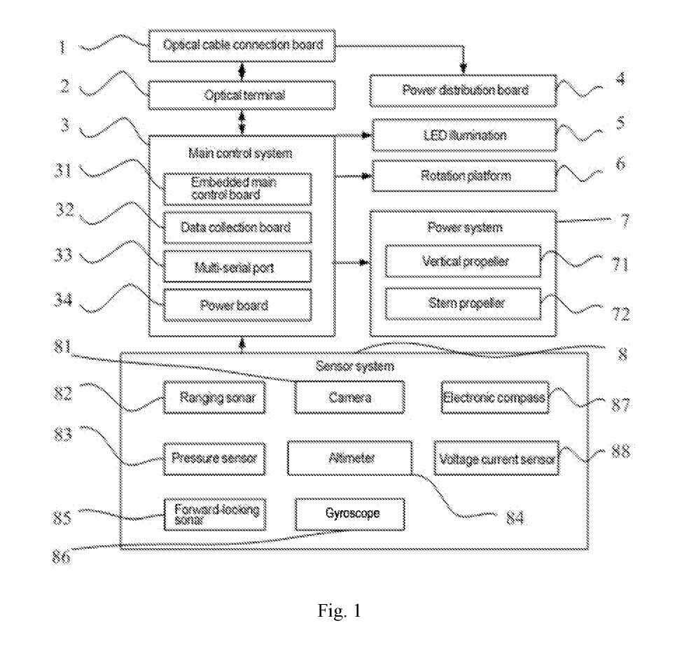

As in FIG. 1, an underwater body for remotely operated vehicle includes: optical cable connection board 1, optical terminal 2, main control system 3, power distribution board 4, LED illumination 5, rotation platform 6, power system 7 and sensor system 8.

Said optical cable connection board 1, optical terminal 2, main control system 3, power distribution board 4, power system 7 and sensor system 8 are arranged inside the electronic vessel of remotely operated vehicle. LED illumination 5, rotation platform 6, power system 7 and part of sensor components of sensor system 8 are arranged in the aluminum alloy frame of remotely operated vehicle.

The output terminal of optical cable connection board 1 communicates with the input terminals in optical terminal 2 and power distribution board 4, the input terminal of optical cable connection board 1 communicates with the output terminal of control center above water via optical composite cable. The input terminal of optical terminal 2 communicates with the output terminals in main control system 3, the output terminal of optical terminal 2 communicates with the input terminal of optical cable connection board 1. Thus main control system 3 communicates with the control center above the water via optical terminal 2, is optical cable connection board 1 and optical composite cables, receives remote control command from the center above water and uploads the video information and sensor data for subsea. In addition, optical cable connection board 1 also provides power to remotely operated vehicle via optical composite cable and delivers the power to power distribution board 4.

The main control system 3 includes: embedded main control board 31, data collection board 32, multi-serial port 33 and power board 34. Data collection board 32, multi-serial port 33 and power board 34 connect with embedded main control board 31 respectively.

Embedded main control board 31 is arranged inside the electronic vessel of underwater body for remotely operated vehicle; the device would receive all sensor data from sensors in the sensor system 8, and transmit such data to the control center above the water via optical terminal 2, optical cable connection board 1 and optical composite cable according to communication protocol; meanwhile receive and analyze the movement control command from the control center above the water via optical terminal 2, optical cable connection board 1 and optical composite cable, transmit such command to the power system 7 to change the movement of remotely operated vehicle.

Data collection board 32 is arranged inside the electronic vessel of underwater body for remotely operated vehicle; the device would receive the digital and analogue sensor data from sensor system 8 and transmit the collected data to the embedded main control board 31, such data would be processed by the embedded main control board 31 and transmitted to control center above water for processing and display, meanwhile the device would deliver the movement control command to the power system 7 of underwater body.

Multi-serial port board 33 is arranged inside the electronic vessel of underwater body for remotely operated vehicle; the device would receive the sensor data from RS485 and RS232 in sensor system 8 and transmit the collected data to the embedded main control board 31, such data would be processed by the embedded main control board 31 and transmitted to control center above water for processing and display.

The power board 34 is arranged inside the electronic vessel of underwater body for remotely operated vehicle; the device would supply power to embedded main control board 31 and certain sensor components in sensor system 8.

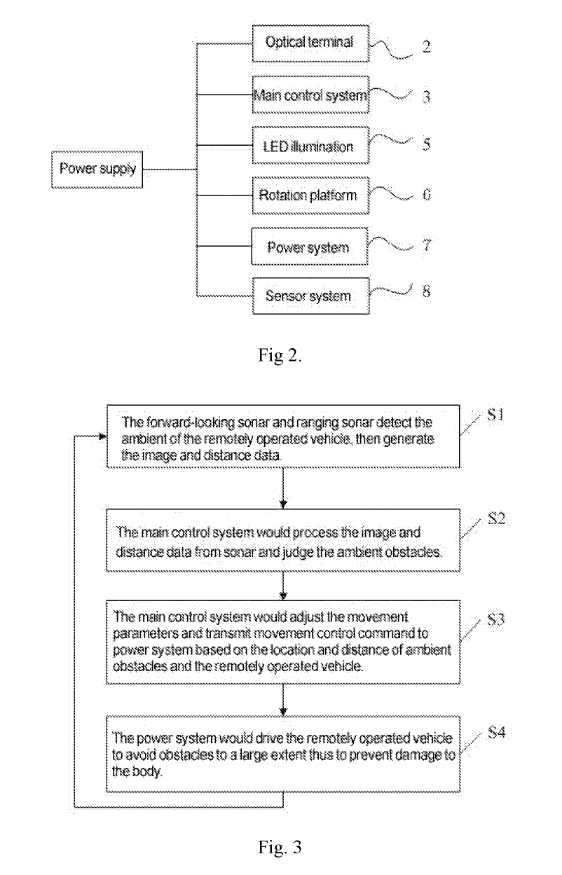

As in FIG. 2 and with reference of FIG. 1, the output terminal of power distribution board 4 connects with optical terminal 2, main control system 3, LED illumination 5, rotation platform 6, power system 7 and sensor system 8 respectively, while the input terminal of such board connects with the output terminal of optical cable connection board 1. The power distribution board 4 would receive the power from optical cable connection board 1, and distribute the power based on the specific power demand in each device to optical terminal 2, main control system 3, LED illumination 5, rotation platform 6, power system 7 and sensor system 8.

The input terminal of LED illumination 5 which connects with the output terminal of data collection board 32, would provide underwater illumination for remotely operated vehicle.

Rotation platform 6 is equipped with video receiver similar to camera 81, and the input terminal of the rotation platform 6 is communicated with the output terminal of multi-serial port 33 in main control system 3, while the main control system 3 controls the rotation platform 6 according to the control command and cause the video receiver to rotate.

The power system 7 serves as the movement component of the underwater body, receives the movement control command transmitted from the main control system 3 and provides power for the movements of remotely operated vehicle. The power system 7 comprises vertical propeller 71 and stern propeller 72. The vertical propeller 71 and stern propeller 72 connect with data collection board 32 respectively.

Vertical propeller 71 is arranged in the bow and stern ends in the vertical section of remotely operated vehicle, to control the diving and floating as well as trim movement of the remotely operated vehicle.

Stern propeller 72 is arranged in both the left side and right side of stern in the frame of remotely operated vehicle, to control the forward and backward movement as well as heading movement of the remotely operated vehicle.

Sensor system 8 would detect the subsea environment in real-time manner and transmit the subsea environment information to main control system, where the main control system deliver movement control command to the movement component of the underwater body based on the subsea environment information, and transmit such data to control center above water for processing and display.

Sensor system 8 comprises camera 81, ranging sonar 82, pressure sensor 83, altimeter 84, forward-looking sonar 85, gyroscope 86, electronic compass 87 and voltage current sensor 88, the system would receive data via data collection board 32 and multi-serial port 33 and such data would be processed by embedded main control board 31.

Camera 81 serving as video receiving device, is arranged in the upper front part of aluminum frame of remotely operated vehicle and mechanically connected with rotation platform 6, the camera 81 is used to collect video of front environment for underwater operation, the rotation of camera 81 would be driven by the rotation platform 6 for the purpose to maximize the observation scope of camera 81, the image data collected by camera 81 would be processed by embedded main control system 3 and transmitted via optical terminal 2, optical cable connection board 1 and optical composite board to control center above water for processing and display.

Ranging sonar 82 is arranged in the upper front end of frame in remotely operated vehicle, to measure the distance to the target ahead or to obstacles, the distance data collected would be received via multi-serial port 33 and processed by embedded main control board 31 as the basis for autonomous obstacle avoidance decision making, meanwhile the device would transmit the measured distance data to control center above water for processing and display.

Pressure sensor 83 is arranged in the lower rear end of frame in remotely operated vehicle, which is configured to measure the depth of the location for underwater operation, the depth data collected would be received via multi-serial port 33 and transmitted to the control center above water for processing and display after processed by embedded main control board 31.

Altimeter 84 is arranged in the aluminum frame of remotely operated vehicle, to measure the altitude where the remotely operated vehicle located and transmit the collected altitude data to the control center above water for processing and display via the main control system 3;

Forward-looking sonar 85 is arranged in the upper front end of frame in remotely operated vehicle, which is configured to detect the condition of ambient target or obstacles of same horizontal level and provide correspondent sonar image data, the sonar image data collected would be received via multi-serial port 33 and processed by embedded main control board 31 as the basis for autonomous obstacle avoidance decision making, meanwhile the device would transmit such data to control center above water for processing and display with optical terminal 2.

Gyroscope 86 is arranged inside the vessel of underwater body, to measure the heading angular velocity of the remotely operated vehicle, the angular velocity data collected would be received via data collection board 32 and transmitted to the control center above water for processing and display after processed by embedded main control board 31.

Electronic compass 87 is arranged inside the vessel of underwater body, to measure the heading angle, trim angle and rolling angle of the remotely operated vehicle, the position data collected would be received and processed by embedded main control board 31 and transmitted to the control center above water for processing and display.

Voltage current sensor 88 is arranged inside the vessel of underwater body, to measure the voltage and current in power system as well as the current consumption in other components, the voltage current data collected would be received via data collection board 32 and transmitted to the control center above water for processing and display after processed by embedded main control board 31.

As shown in FIG. 3, the invention also discloses an autonomous obstacle avoidance method deployed in underwater body for remotely operated vehicle, and the said autonomous obstacle avoidance method comprises:

Step 1, the forward-looking sonar and ranging sonar detect the ambient of the remotely operated vehicle, then transmit the image data and distance data generated to the main control system.

Step 2, the main control system would process the image and distance data from forward-looking sonar and ranging sonar and obtain the location and distance relationship between the remotely operated vehicle and ambient obstacles, and complete the judgment against ambient obstacles.

Step 3, the main control system would adjust the movement parameters and transmit movement control command to power system based on the location and distance relationship between the remotely operated vehicle and ambient obstacles.

Step 4, the power system would drive the remotely operated vehicle to avoid obstacles to a large extent thus to prevent damage to the body. Then skip to step 1 after the obstacle avoidance movement completed and realize autonomous obstacle avoidance in cycle.

While the instant invention has been shown and described herein in what are conceived to be the most practical and preferred embodiment, it is recognized that the scope of the invention is not to be limited to the details disclosed herein. It is clear that various amendments and modifications to this invention may be made by those skilled in the art after reading the above description off the invention. Therefore the protection scope of this invention shall limited as recited in the appended claims.

1. An underwater body for remotely operated vehicle fixed in the frame of remotely operated vehicle, wherein, said underwater body includes,
a main control system which communicates with the control center above the water with optical composite cable and receives remote control command from the center above water and uploads the video information and sensor data for subsea;
a rotation platform equipped with video receiver, and the input terminal of the rotation platform communicates with the main control system, while the main control system controls the rotation platform according to the control command and cause the video receiver to rotate;
a sensor system which comprises sonar component, the sonar component would detect the subsea environment in real-time manner and transmit the subsea environment information to main control system, where the main control system deliver movement control command to the movement component of the underwater body based on the subsea environment information.

2. The underwater body for remotely operated vehicle of claim 1, wherein, said main control system includes:
an embedded main control board which uploads the sensor data from sensor system to the control center above the water, receive remote control command from the control center above water, analyze the command received, and then deliver the movement control command to the underwater body;
a data collection board which communicates with the embedded main control board, receives the digital and analogue sensor data from sensor system and transmit such data to the embedded main control board, then delivers the movement control command to the movement component of the underwater body;
a multi-serial port board which communicates with the embedded main control board, receives the sensor data from RS485 and RS232 in sensor system and transmit such data to the embedded main control board; the multi-serial port board also connects with optical composite cable; the embedded main control board connects with the control center above water with multi-serial port board.

3. The underwater body for remotely operated vehicle of claim 1, wherein, said main control system communicates with optical cable connection board via optical terminal, and connects optical composite cable via optical cable connection board, thus to establish communication with control center above water via optical composite cable.

4. The underwater body for remotely operated vehicle of claim 1, wherein, said underwater body also includes a power system, said power system serves as the movement component of the underwater body, receives the movement control command transmitted from the main control system and provides power for the movements of remotely operated vehicle;
said power system includes:
a vertical propeller which is arranged in the bow and stern ends in the vertical section of remotely operated vehicle, to control the diving and floating as well as trim movement of the remotely operated vehicle;
a stern propeller which is arranged in both the left side and right side of stern in the frame of remotely operated vehicle, to control the forward and backward movement as well as heading movement of the remotely operated vehicle.

5. The underwater body for remotely operated vehicle of claim 1, wherein, said underwater body also includes power distribution board, the input terminal of such board connects with optical cable connection board to receive the power delivered from the optical cable connection board, and distributes the power to optical terminal, main control system, rotation platform, sensor system and movement component in the underwater body.

6. The underwater body for remotely operated vehicle of claim 1, wherein, said sonar component includes:
a ranging sonar which is arranged in the upper front end in remotely operated vehicle, to measure the distance to the target ahead or to obstacles, then transmit the measured distance data to the main control system and control center above water for processing;
a forward-looking sonar which is arranged in the upper front end in remotely operated vehicle, to detect the condition of ambient target or obstacles of same horizontal level, then transmit the measured distance data to the main control system and control center above water for processing.

7. The underwater body for remotely operated vehicle of claim 1, wherein, said sensor system includes:
a camera, serves as video receiving device, which is arranged in the front of said remotely operated vehicle and connected with rotation platform, would be rotate caused by the rotation platform, to collect the image data, transmit the data to the control center above water via the main control system;
a pressure sensor, which is arranged in the lower rear part of underwater body, to inspect the depth where the remotely operated vehicle located and transmit the collected depth data to the control center above water via the main control system;
an altimeter, to measure the altitude where the remotely operated vehicle located, and to transmit the collected altitude data to the control center above water via the main control system;
a gyroscope, which is arranged inside the vessel of underwater body, to measure the heading angular velocity of the remotely operated vehicle and transmit the collected angular velocity data to the control center above water via the main control system;
an electronic compass, which is arranged inside the vessel of underwater body, to measure the heading angle, trim angle and rolling angle of the remotely operated vehicle and transmit the collected angular velocity data to the control center above water via the main control system;
a voltage current sensor, which is arranged inside the vessel of underwater body, to measure the voltage and current information of each part of the remotely operated vehicle, and to transmit the collected angular velocity data to the control center above water via the main control system.

8. An autonomous obstacle avoidance method deployed in underwater body for remotely operated vehicle, wherein, said obstacle avoidance method comprises:
step 1, the forward-looking sonar and ranging sonar detect the ambient of the remotely operated vehicle, then transmit the image and distance data generated to the main control system;
step 2, the main control system would process the image and distance data from forward-looking sonar and ranging sonar and obtain the location and distance relationship between the remotely operated vehicle and ambient obstacles;
step 3, the main control system would adjust the movement parameters and transmit movement control command to power system based on the location and distance relationship between the remotely operated vehicle and ambient obstacles;
step 4, the power system would drive the remotely operated vehicle to avoid obstacles then skip to step 1 and realize autonomous obstacle avoidance in cycle.
